(19) United States
(12) Patent Application Publication
(10) Pub. No.: US 2014/0099626 A1
(43) Pub. Date: Apr. 10, 2014

(54) MECHANISM FOR AUTOMATING THE PROCESS OF INDIVIDUAL LEARNER COURSE SELECTION IN A LEARNING MANAGEMENT SYSTEM (LMS)

(71) Applicant: Medical Risk Management LLC, Hartford, CT (US)

(72) Inventors: Kevin William Kelly, West Hartford, CT (US); Jeffrey Scott Jorczak, South Windsor, CT (US)

(73) Assignee: Medical Risk Management LLC, Hartford, CT (US)

(21) Appl. No.: 14/045,825

(22) Filed: Oct. 4, 2013

Related U.S. Application Data
(60) Provisional application No. 61/710,203, filed on Oct. 5, 2012.

(51) Int. Cl. G09B 5/02

(52) U.S. Cl. CPC G09B 5/02
USPC 434/362

(57) ABSTRACT

Embodiments include a method, system and computer program product for automating individual learner course selection. The method includes accessing, by a computer processor, course descriptions for a plurality of variants of a course. The course descriptions include course variant characteristics and course variant titles. The course variant characteristics define target audiences for each of the variants of the course. Information about a user, including user characteristics is received. The course variant characteristics are compared to the user characteristics. Based on the comparing, a specificity value is calculated for each of the variants of the course. The specificity value indicates a degree of match between the user and a target audience of the variant of the course. A variant of the course is selected for the user based on the specificity values, and the course title of the selected variant of the course is output.

### CROSS-REFERENCE TO RELATED APPLICATION

This application claims the benefit of U.S. Provisional Application No. 61/710,203, filed Oct. 5, 2012, and entitled “A Mechanism For Automating the Process of Individual Learner Course Selection in a Learning Management System (LMS)”, the content of which is incorporated herein by reference in its entirety.

### BACKGROUND

The present invention relates to automating course selection, and more specifically, to a mechanism for automating the process of individual learner course selection in a learning management system (LMS).

In a typical LMS, a set of courses are offered for the learners to take. These courses may be intended for general audiences, or they may be more specific for smaller, more specialized, groups of people. The decision about what courses apply to each individual is made by the learners themselves or by a person acting as an administrator.

### SUMMARY

Embodiments include a method, system and computer program product for automating individual learner course selection. The method includes accessing, by a computer processor, course descriptions for a plurality of variants of a course. The course descriptions include course variant characteristics and course variant titles. The course variant characteristics define target audiences for each of the variants of the course. Information about a user, including user characteristics is received. The course variant characteristics are compared to the user characteristics. Based on the comparing, a specificity value is calculated for each of the variants of the course. The specificity value indicates a degree of match between the user and a target audience of the variant of the course. A variant of the course is selected for the user based on the specificity values, and the course title of the selected variant of the course is output.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a process for automatically producing a personalized learning experience recommendation in accordance with an embodiment;

FIG. 2 illustrates a block diagram of a characteristics assigned to course variants in accordance with an embodiment;

FIG. 3 illustrates a block diagram of learner classification in accordance with an embodiment;

FIG. 4 illustrates a block diagram of a data model in accordance with an embodiment;

FIG. 5 illustrates a user interface screen in accordance with an embodiment; and

FIG. 6 illustrates a block diagram of an exemplary system for automatically producing a personalized learning experience recommendation in accordance with an embodiment.

### DETAILED DESCRIPTION

Embodiments described herein are directed to a learning management system (LMS) that automatically builds a customized curriculum for individual learners based on their unique characteristics. In an embodiment, a set of characteristics is assigned to each learner. The system then matches these characteristics to the characteristics of each course variant using an algorithm or set of rules to determine which course variants to apply to each learner. Characteristics include any attribute, trait, or classification that describes a learner or a course variant, and they vary depending on the subject matter and target audience. Example characteristics from the healthcare industry include, but are not limited to specialty, setting, and medical role.

Embodiments include a mechanism (e.g., computer software application) through which the process of individual course selection is automated. Once characteristics are assigned to both the learners and the courses, software algorithms are applied to automatically match the most appropriate courses to each individual learner.

As used herein, the term “learner” refers to a person engaged in the experience of learning (e.g., a student). As used herein, the term learner is synonymous with the term “user” which includes a person, entity, or external system.

As used herein, the term “course” refers to any educational material designed to impart knowledge. Examples include, but are not limited to live instruction, recorded videos, brochures, tests, computer based learning, and self-paced learning.

As used herein, the term “variant” refers to a variation of a course, sharing the same theme or objective, but differing in the precise content and/or presentation. The terms “variant” and “course variant” are used interchangeably herein.

As used herein, the term “characteristic” refers to a trait, classification, population, etc., that is used to describe qualities of either learners or courses.

As used herein, the term “category” refers to a logical grouping of similar or related characteristics. For example, the category “employment” could include both the “volunteer” and “full time” characteristics.

As used herein, the term “specificity value” refers to a value that indicates how specific something is (e.g., how good a match a particular course is to a particular learner, or a degree of match between a target audience of a course variant and a learner), with a larger specificity value indicating that the item is more specific.

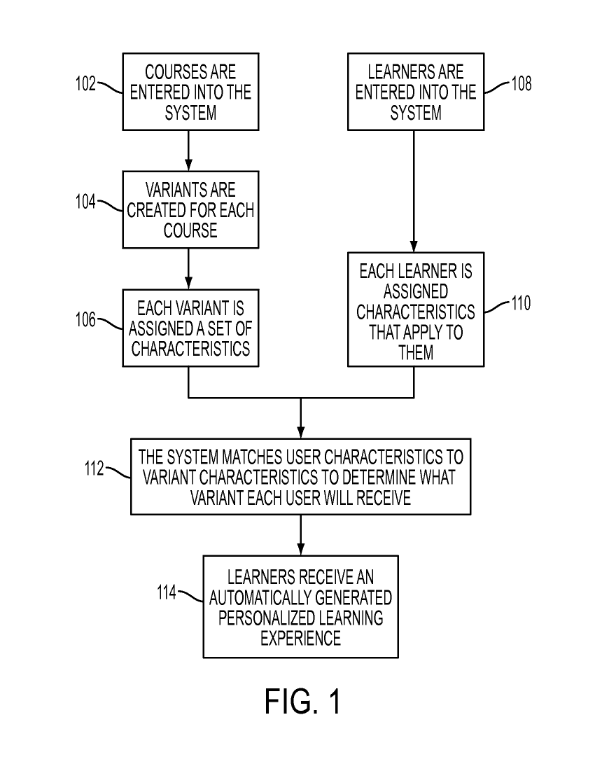

Turning now to FIG. 1, a process for automatically producing a personalized learning experience recommendation in accordance with an embodiment is generally shown. In an embodiment, the process shown in FIG. 1 is performed by computer instructions executing on a computer processor. An embodiment is described using an example in the healthcare industry where learners are healthcare workers and courses are targeted to different types of healthcare workers. At block 102, course descriptions (e.g., topics) are entered into the system. At block 104, one or more of the topics are customized in order to provide more value to particular types of audiences. These customizations are referred to as variants. Table 1 shows example descriptions of courses and their variants. Two courses are shown in Table 1: Medical Procedures and HIPAA Training. The Medical Procedures course has a Generic Variant that applies to all healthcare workers, a Variant 1 that applies to pediatric residents, a Variant 2 that applies to operating room personnel, and a Variant 3 that applies to office staff. The course variants are used to account for the differences in training about medical procedures required for pediatric residents, operating room personnel and office staff.

TABLE 1
Example Courses and Variants

| Topic | Generic Variant | Variant1 | Variant2 | Variant3 | . . . |
|---|---|---|---|---|---|
| Medical | Medical Procedures | Medical Procedures | Medical Procedures | Medical Procedures | . . . |
| Procedures | for Everyone | for Pediatric | for Operating Room | for Office | |
| | | Residents | Personnel | Staff | |
| HIPAA Training | HIPAA Issues | HIPAA Issues for | HIPAA Issues for | HIPAA Issues for | . . . |
| | | Nurses | Doctors | Therapists | |
| . . . | . . . | . . . | . . . | . . . | . . . |

Each variant applies to a particular audience, and at block 106 in FIG. 1, each course variant is assigned a set of characteristics which define the target set of learners to receive that variant of the course.

In an embodiment, the characteristics are from a predefined list that is entered into the system as part of an initial configuration process. As described previously, characteristics are any trait that can be used to classify a group of people, and they may or may not be grouped into categories to handle characteristics with related themes. Table 2 includes an example of four possible categories of characteristics in a healthcare setting and associated characteristics in each the categories that may have been entered into the system during the initial configuration process.

TABLE 2
Example Characteristics

| | | | Medical | Employ- | |
|---|---|---|---|---|---|
| Category | Specialties | Settings | Roles | ment | . . . |
| Characteristic | Surgery | Hospital | Physician | Staff | . . . |
| | Pediatrics | Physician | Nurse | Exempt | . . . |
| | | Group | | | |
| | Anesthesiology | Residency | Staff | Per Diem | . . . |
| | Psychiatry | Nursing | Therapist | Volunteer | . . . |
| | | Home | | | |
| | . . . | . . . | . . . | . . . | . . . |

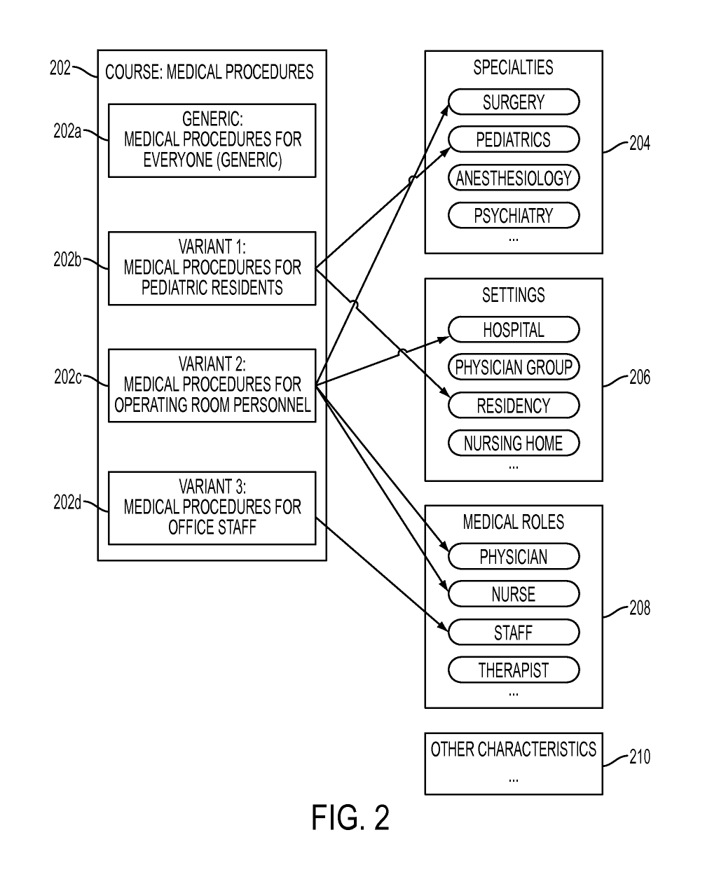

Turning now to FIG. 2, a block diagram of characteristics assigned to course variants upon completion of block 106 in FIG. 1 in accordance with an embodiment is generally shown. As shown in FIG. 2, and as described previously, the Medical Procedures course 202 has a Generic Variant 202a that applies to all healthcare workers, a Variant 1 202b that applies to pediatric residents, a Variant 2 202c that applies to operating room personnel, and a Variant 3 202d that applies to office staff. Also shown in FIG. 2 are characteristics broken up into the categories: specialties category 204, settings category 206, medical roles category 208, and others category 210. Each variant (Variant 1 202b, Variant 2 202c, Variant 3 202d) in the Medical Procedures course 202 is assigned to one or more the characteristics in one or more of the categories (specialties category 204, settings category 206, medical roles category 208, and others category 210). FIG. 2 shows an embodiment of an assignment of course variants based on characteristics of learners that are generated by block 106 in FIG. 1.

Referring back to FIG. 1, upon completion of block 106, course content (e.g., actual course content, course title, and/or instructions on how to access or sign up for the course) is ready to be delivered to the learners.

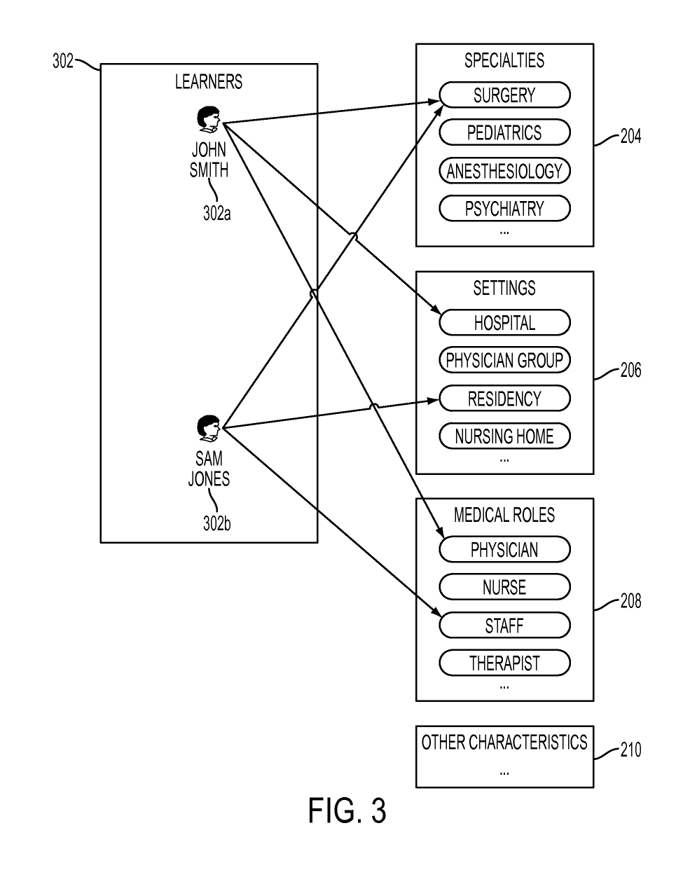

Continuing with reference to FIG. 1, blocks 108-110 are performed independently of blocks 102-104. At block 108, information about learners is entered into the system. In an embodiment, user accounts are created for each individual who will be using the system and receiving courses. A user account may simply be a unique record used to identify a learner as they log into the system. Typically, such an account will have a first and last name, a password, and a unique identifier or key. At block 110 of FIG. 1, each learner is assigned a set of characteristics that applies to that learner. A learner can be associated with any number of characteristics, and different learners can be associated with different characteristics. The process for assigning characteristics may be performed by a system support person, by the learners themselves, and/or automatically by the system (e.g., based on human resource records or other computer records). Table 3 shows an example of several learners and their assigned characteristics, and FIG. 3 depicts an example of a learner classification.

TABLE 3
Example Learners

| User | First | Last | Specialty | Setting | Medical Role | Employment | . . . |
|---|---|---|---|---|---|---|---|
| 1 | John | Smith | Surgeon | Hospital | Physician | Full Time | . . . |
| 2 | Jane | Doe | Surgeon | Hospital | Physician | Full Time | . . . |
| 3 | Sam | Jones | Surgeon | Residency | Staff | Volunteer | . . . |
| 4 | Many | Hall | Pediatician | Physician Group | Nurse | Per Diem | . . . |
| . . . | . . . | . . . | . . . | . . . | . . . | . . . | . . . |

Turning now to FIG. 3, a block diagram of learner classification in accordance with an embodiment is generally shown. The learners 302 shown in FIG. 3 include John Smith 302a and Sam Jones 302b. John Smith 302a is characterized as having a characteristic of surgery in the specialties category 204, a characteristic of hospital in the settings category 206, and a characteristic of physician in the medical roles category 208. Sam Jones 302b is characterized as having a characteristic of surgery in the specialties category 204, a characteristic of residency in the settings category 206, and a characteristic of staff in the medical roles category 208. The block diagram of FIG. 3 depicts learners and assigned sets of characteristics that apply to the learners as generated by an embodiment of block 110 in FIG. 1.

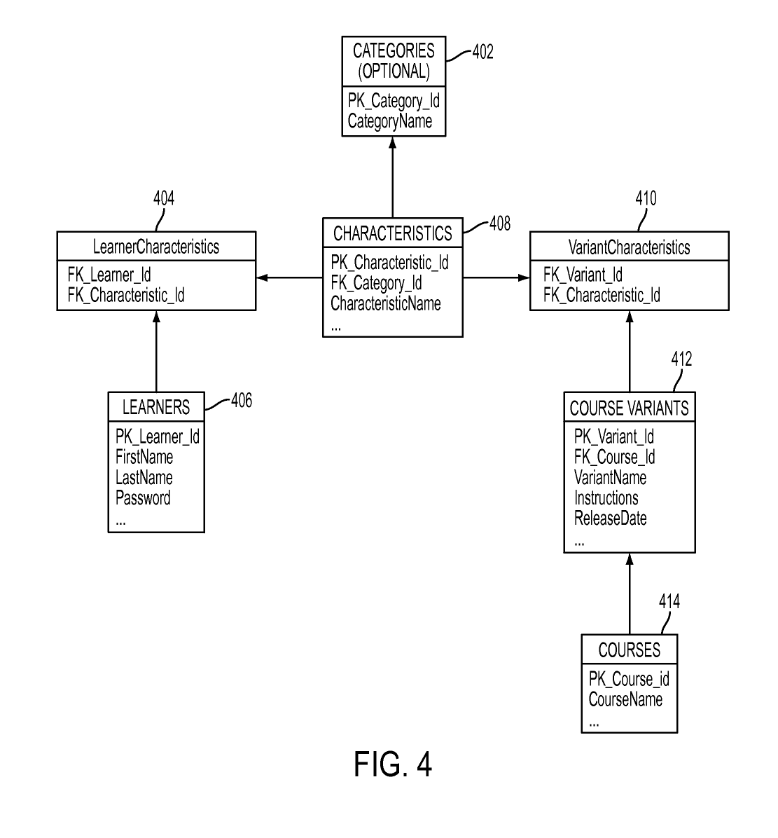

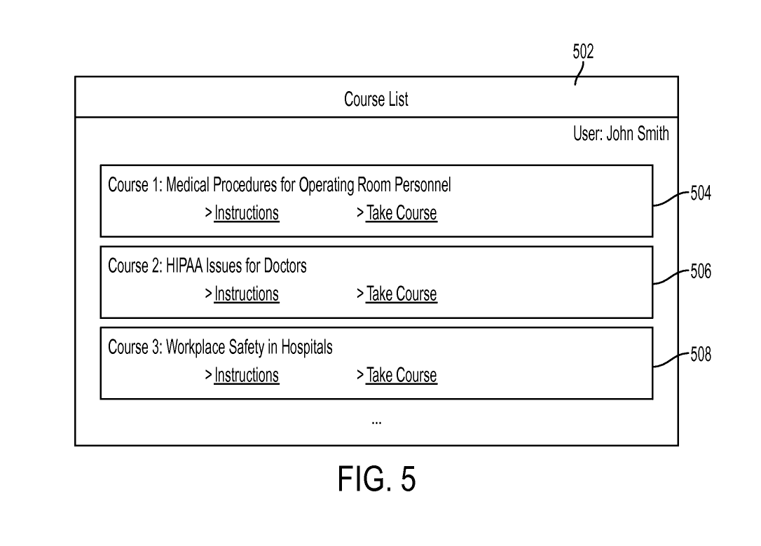

Referring back to FIG. 1, when blocks 106 and 110 are completed, all of the required relationships are now established for generating customized curriculums for individual learners. See FIG. 4 for an embodiment of a data model that reflects these relationships. At block 112 in FIG. 1, the system matches user characteristics to course variant characteristics to determine what course variant each user will receive. Next, at block 114, each learner can log in and receive a personalized list of course variants based on how their characteristics match up with those of the course variants. An embodiment of a user output screen that is presented to learners is shown in FIG. 5. The embodiment shown in FIG. 5 includes a list of recommended courses, and for each course instructions about the course and information on how to take the course. Each learner may then proceed to take the recommended courses.

In an embodiment, any recommended course variants that are available on-line are automatically order and/or made accessible to the user (e.g., via downloading the material and/or via registering the user for the course). In an embodiment, the system automatically initiates registering (also referred to herein as “enrolling”) the user for any recommended courses. In another embodiment, the system asks the learner if they would like to register for the courses prior to initiating registration to the recommended course variants. In another embodiment, the list of recommended courses (including, e.g., course titles) is communicated to the learner (and other interested personnel such as the learner's supervisor) via an electronic message and/or via a printed document.

In an embodiment, the matching of user characteristics to variant characteristics to determine what course variant each user will receive, as performed at block 112 of FIG. 1, uses a specificity value for each course variant to determine how good a match a particular variant is to a particular learner. Embodiments described herein give each learner the most specific course variant to match their characteristics and thus, delivers the learner the most relevant content possible. In an embodiment, a learner is compared to a course (e.g., a set of course variants) and a specificity value for each course variant (which indicates a degree of match between the course variant and the learner) is calculated. Table 4 shows an example of a method that totals the number of characteristic matches to determine the specificity value.

TABLE 4
Example Specificity Assignment by Characteristic Match

| | Surgery | Pediatrics | Hospital | ER | Residency | Physician | Nurse | Full Time | | Specificity |
|---|---|---|---|---|---|---|---|---|---|---|
| John Smith | Has | | Has | | | Has | | Has | . . . | |
| Medical Procedures for | Has | | | Has | | Has | Has | Has | . . . | 3 |
| Operating Room | (match) | | | (no match) | | (match) | (no match) | (match) | | |
| Personnel | | | | | | | | | | |
| Medical Procedures for | | | Has | | | Has | | | . . . | 2 |
| Hospital Physicians | | | (match) | | | (match) | | | | |
| Medical Procedures for | Has | | | | | | | | . . . | 1 |
| Surgeons | (match) | | | | | | | | | |
| Medical Procedures for | | | Has | | | | Has | | . . . | 1 |
| Hospital Nurses | | | (match) | | | | (no match) | | | |
| Medical Procedures for | | | | | | | | | . . . | 0 |
| Everyone | | | | | | | | | | |
| Medical Procedures for | | Has | | | Has | | | | . . . | 0 |
| Pediatric Residents | | (no match) | | | (no match) | | | | | |
| Medical Procedures for | | | | | | | | Has | . . . | 0 |
| Office Staff | | | | | | | | (no match) | | |
| . . . | . . . | | . . . | | | . . . | | | . . . | . . . |

In this example, the learner John Smith has the surgery, hospital, physician, and full time characteristics, as shown at the top of Table 4. The left column of Table 4 lists several variants for the Medical Procedures course, including: Medical Procedures for Operating Room Personnel, Medical Procedures for Hospital Physicians, and so on. Each of these course variants also has characteristic assignments as shown in the center of Table 4. For example, the variant Medical Procedures for Hospital Physicians has the characteristics Hospital and Physician. The specificity value for each variant is calculated relative to the learner by adding up how many characteristics match between the two. For example, for the course variant Medical Procedures for Operating Room Personnel, the variant and learner match on the characteristics surgery, physician, and full time but do not match on ER or nurse. The number of characteristic matches between the course variant and the learner are counted to generate a specificity value of three. The specificities of all of the example variants in Table 4 are shown in the last column of Table 4. Once the specificities are calculated, variants are sorted in order of descending specificity and the one at the top which is the “most specific” (or that has the highest degree of match) is the course variant that will be recommended for the learner at block 112 of FIG. 1.

In another embodiment, the matching of user characteristics to variant characteristics to determine what course variant each user will receive, as performed at block 112 of FIG. 1, takes into account the case where more than one variant has the same highest specificity. An example of this is shown in Table 5 where characteristic categories are assigned a weighting value which is used during the specificity value calculation. This results in matches between certain characteristics of the learner and the course variant having a higher priority in the matching algorithm.

TABLE 5
Example Specificity Assignment by Weighted Categories

| Category | Setting | Specialty | Medical Role | Employment | | Specificity |
|---|---|---|---|---|---|---|
| Weight | 1000 | 100 | 10 | 1 | | |
| John Smith | Hospital | Surgery | Physician | Full Time | . . . | |
| Medical Procedures | Hospital | | Physician | | . . . | 1010 |
| for Hospital Physicians | (match) | | (match) | | | |
| Medical Procedures | Hospital | | Nurse | | . . . | 1000 |
| for Hospital Nurses | (match) | | (no match) | | | |
| Medical Procedures | ER | Surgery | Physician | Full Time | . . . | 111 |
| for Operating Room | (no match) | (match) | (match) | (match) | | |
| Personnel | | | Nurse | | | |
| | | | (no match) | | | |
| Medical Procedures | | Surgery | | | . . . | 100 |
| for Surgeons | | (match) | | | | |
| Medical Procedures | | | | Full Time | . . . | 1 |
| for Office Staff | | | | (match) | | |
| Medical Procedures | | | | | . . . | 0 |
| for Everyone | | | | | | |
| Medical Procedures | Residency | Pediatrics | | | . . . | 0 |
| for Pediatric | (no match) | (no match) | | | | |
| Residents | | | | | | |
| . . . | . . . | . . . | . . . | . . . | . . . | . . . |

The “Weight” row in Table 5 indicates that the setting category of characteristics has a weight of 1000, the specialty category of characteristics has a weight of 100, the medical role category of characteristics has a weight of 10, and the employment category of characteristics has a weight of 1. There could be any number of additional characteristic categories and weight values, but this example shows only four for brevity. Similar to the example described above with respect to Table 4, the characteristics of the variants and the learner are compared to determine what they have in common; but unlike the example described with respect to Table 4, the weight value of each characteristic category is taken into account when calculating specificity. For the variant Medical Procedures for Operating Room Personnel, John Smith matches on surgery (specialty category), physician (medical role category), and full time (employment category). Adding the weights of these categories give a specificity value of 100+10+1=111. Looking at the Medical Procedures for Hospital Physicians variant, John Smith matches on hospital (setting category) and on physician (medical role category). Therefore, the specificity of this course variant is higher at a value of 1000+10=1010 even though it has a fewer number of matches.

After the weighted specificity value for each variant is calculated, the variants are sorted by their specificity from highest to lowest to allow selection of the variant that most closely matches the weighted characteristics of the learner, in this case the course variant Medical Procedures for Hospital Physicians.

It should be noted that these two examples produced different results. The example described with respect to Table 4 selected the variant Medical Procedures for Operating Room Personnel and the example described with respect to Table 5 selected the variant Medical Procedures for Hospital Physicians. This illustrates that many derivations of the matching algorithms may be utilized in accordance with embodiments depending on the business needs. Embodiments are not specific to these two examples, but cover any similar methods using the concepts described herein.

In other embodiments, two (or more) variants with the highest specificity are selected. In another embodiment, the two closest variants are selected if the two variants with the highest specificity are within a pre-specified range of each other.

In other embodiments the weight value of each characteristics is taken into account when calculating specificity

The examples described herein are directed to a learning curriculum for health care workers. Embodiments are not limited to health care worker education and may be utilized to provide customized education plans in any area where training may differ based on learner characteristics. Examples include, but are not limited to learning curriculums for workers in industries such as insurance, technology, transportation, and retail.

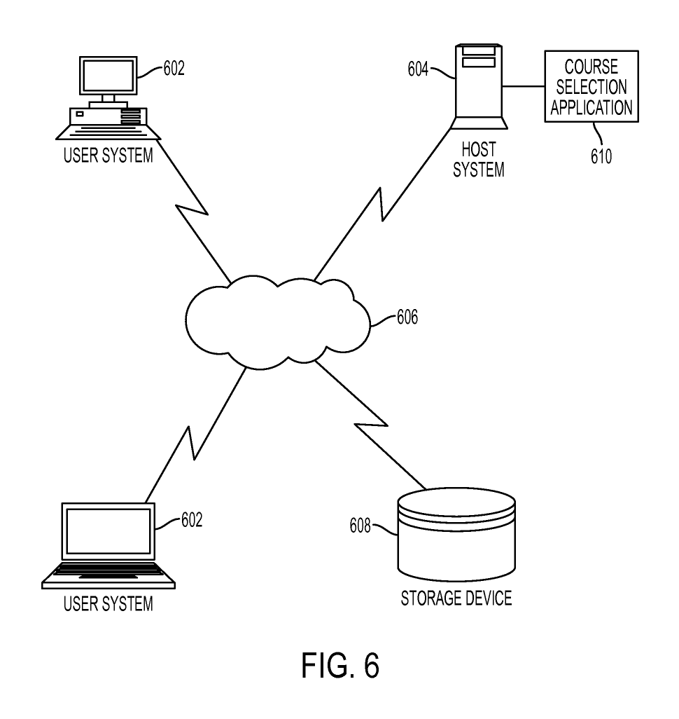

Referring to FIG. 6, a block diagram of an exemplary system for automatically producing a personalized learning experience recommendation is generally shown. The system includes a course selection application 610 that is executed by one or more computer programs located on a host system 604. The system depicted in FIG. 6 includes one or more user systems 602 through which users (e.g., learners, administrators) at one or more geographic locations may contact the host system 604. In an embodiment, users perform the processing described above in blocks 102-110 of FIG. 1 via the user systems 602. In addition, the output screen generated by block 114 of FIG. 1 and shown in FIG. 6 is an example of a user interface that may be presented to a user via a display in a user system 602. The user systems 602 are coupled to the host system 604 via a network 606. Each user system 602 may be implemented using a general-purpose computer executing a computer program for carrying out the processes described herein. The user systems 602 may be personal computers (e.g., a lap top, a tablet computer, a cellular telephone) or host attached terminals. If the user systems 602 are personal computers, the processing described herein may be shared by a user system 602 and the host system 604.

The network 606 may be any type of known network including, but not limited to, a wide area network (WAN), a local area network (LAN), a global network (e.g. Internet), a virtual private network (VPN), and an intranet. The network 106 may be implemented using a wireless network or any kind of physical network implementation known in the art. A user system 602 may be coupled to the host system through multiple networks (e.g., cellular and Internet) so that not all user systems 602 are coupled to the host system 604 through the same network. One or more of the user systems 602 and the host system 604 may be connected to the network 606 in a wireless fashion. In one embodiment, the network is the Internet and one or more user systems 602 execute a user interface application (e.g. a web browser) to contact the host system 604 through the network 606. In another exemplary embodiment, the user system 602 is connected directly (i.e., not through the network 606) to the host system 604. In a further embodiment, the host system 604 is connected directly to or contains the storage device 608.

The storage device 608 includes data relating to automating the process of individual learner course selection in a learning management system (LMS) and may be implemented using a variety of devices for storing electronic information. In an embodiment, data stored in the storage device 608 includes, but is not limited to, course descriptions and user descriptions, as well as characteristics and the data model shown in FIG. 4. It is understood that the storage device 608 may be implemented using memory contained in the host system 604 or that it may be a separate physical device. The storage device 608 is logically addressable as a consolidated data source across a distributed environment that includes the network 606. Information stored in the storage device 608 may be retrieved and manipulated via the host system 604 and/or via a user system 602. In an embodiment, storage device 608 includes a database for storing all or a subset of the data described herein.

The host system 604 depicted in FIG. 6 may be implemented using one or more servers operating in response to a computer program stored in a storage medium accessible by the server. The host system 604 may operate as a network server (e.g., a web server) to communicate with the user system 602. The host system 604 handles sending and receiving information to and from the user system 602 and can perform associated tasks. The host system 604 may also include a firewall to prevent unauthorized access to the host system 604 and enforce any limitations on authorized access. For instance, an administrator may have access to the entire system and have authority to modify portions of the system. A firewall may be implemented using conventional hardware and/or software as is known in the art.

The host system 604 may also operate as an application server. The host system 604 executes one or more computer programs, including a course selection application 610, to provide automated course selection functions as described herein. Processing may be shared by the user system 602 and the host system 604 by providing an application to the user system 602. Alternatively, the user system 602 can include a stand-alone software application for performing a portion or all of the processing described herein. As previously described, it is understood that separate servers may be utilized to implement the network server functions and the application server functions. Alternatively, the network server, the firewall, and the application server may be implemented by a single server executing computer programs to perform the requisite functions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for automating individual learner course selection, the method comprising:
accessing, by a computer processor, course descriptions for a plurality of variants of a course, the course descriptions including course variant characteristics and course variant titles, the course variant characteristics defining target audiences for each of the variants of the course;
receiving information about a user, the information including user characteristics;
comparing the course variant characteristics and the user characteristics;
based on the comparing, calculating a specificity value for each of the variants of the course, the specificity value indicating a degree of match between the user and a target audience of the variant of the course;
selecting a variant of the course for the user based on the specificity values; and
outputting a course title of the selected variant of the course.

2. The method of claim 1, wherein the course descriptions are stored in a database.

3. The method of claim 1, further comprising assigning weights to one or more of the user characteristics, wherein the calculating a specificity value is further based on the weights.

4. The method of claim 1, further comprising assigning weights to one or more of the course variant characteristics, wherein the calculating a specificity value is further based on the weights.

5. The method of claim 1, wherein the course variant characteristics and the user characteristics are from a predefined list of characteristics.

6. The method of claim 1, further comprising performing at least one of:
ordering the selected variant of the course for the user;
initiating enrollment of the user in the selected variant of the course; and
providing the user with information about how to enroll in the selected variant of the course.

7. The method of claim 1, further comprising providing the user with access to the selected variant of the course.

8. The method of claim 1, further comprising:
selecting a second variant of the course for the user based on the specificity values; and
outputting a course title of the selected second variant of the course.

9. The method of claim 1, further comprising generating a customized curriculum for the user, the generating including performing the accessing, comparing, calculating, selecting, and outputting for the course and at least one other course.

10. The method of claim 1, further comprising generating a customized curriculum for a group of users, the generating including performing the receiving comparing, calculating, selecting, and outputting for the user and a least one other user.

11. The method of claim 1, wherein the course is related to health care and the course variant characteristics include at least one of specialty, setting, and medical role.

12. A computer system for automating individual learner course selection, the computer system comprising:
a processor configured to perform a method comprising:
accessing course descriptions for a plurality of variants of a course, the course descriptions including course variant characteristics and course variant titles, the course variant characteristics defining target audiences for each of the variants of the course;
receiving information about a user, the information including user characteristics;
comparing the course variant characteristics and the user characteristics;
based on the comparing, calculating a specificity value for each of the variants of the course, the specificity value indicating a degree of match between the user and a target audience of the variant of the course;
selecting a variant of the course for the user based on the specificity values; and
outputting a course title of the selected variant of the course.

13. The system of claim 12, wherein the course descriptions are stored in a database.

14. The system of claim 12, wherein the processor is further configured to perform at least one of:
assigning user characteristic weights to one or more of the user characteristics, wherein the calculating a specificity value is further based on the user characteristic weights; and
assigning variant characteristic weights to one or more of the course variant characteristics, wherein the calculating a specificity value is further based on the variant characteristic weights.

15. The system of claim 12, wherein the processor is further configured to perform at least one of:
providing the user with access to the selected variant of the course;
ordering the selected variant of the course for the user;
initiating enrollment of the user in the selected variant of the course; and
providing the user with information about how to enroll in the selected variant of the course.

16. The system of claim 12, wherein the processor is further configured to perform:
selecting a second variant of the course for the user based on the specificity values; and
outputting a course title of the selected second variant of the course.

17. The system of claim 12, wherein the processor is further configured to perform:
generating a customized curriculum for the user, the generating including performing the accessing, comparing, calculating, selecting, and outputting for the course and at least one other course.

18. The system of claim 12, wherein the processor is further configured to perform:
generating a customized curriculum for a group of users, the generating including performing the receiving comparing, calculating, selecting, and outputting for the user and a least one other user.

19. The system of claim 12, wherein the course is related to health care and the course variant characteristics include at least one of specialty, setting, and medical role.

20. A computer program product for automating individual learner course selection, the computer program product comprising:
a computer readable storage medium having computer readable program code embodied therewith, the computer readable program code comprising:
computer readable program code configured for:
accessing course descriptions for a plurality of variants of a course, the course descriptions including course variant characteristics and course variant titles, the course variant characteristics defining target audiences for each of the variants of the course;
receiving information about a user, the information including user characteristics;
comparing the course variant characteristics and the user characteristics;
based on the comparing, calculating a specificity value for each of the variants of the course, the specificity value indicating a degree of match between the user and a target audience of the variant of the course;
selecting a variant of the course for the user based on the specificity values; and
outputting a course title of the selected variant of the course.
